(19) United States
(12) Patent Application Publication
(10) Pub. No.: US 2004/0066371 A1
(43) Pub. Date: Apr. 8, 2004

(54) MOUSE DEVICE AND METHOD WITH THE WIRELESS TRANSMISSION FUNCTION

(76) Inventor: Mark Po-Shaw Huang, Taipei Hsien (TW)

Correspondence Address: BACON & THOMAS, PLLC, 625 SLATERS LANE, FOURTH FLOOR, ALEXANDRIA, VA, 22314

(21) Appl. No.: 10/261,935

(22) Filed: Oct. 2, 2002

(51) Int. Cl. G09G 5/08

(52) U.S. Cl. 345/163

(57) ABSTRACT

A mouse device applying the wireless transmission system utilizes the Micro Electro Mechanical System(MEMS) technology for detecting and verifying the displacement resulting from pressure applied by a user. In addition, the invention enables data transmission through the Radio Frequency(RF) wireless transmission, and a data processing apparatus is able to execute a command. Moreover, the invention utilizes different acceleration and velocity of forces applied by users to distinguish from users' signature habits on the identifications of their signature images. The invention is able to improve the drawbacks of currently applied mouse through a certain angle for the best sensitivity of a mouse device.

### BACKGROUND OF THE INVENTION

1. Field of the Invention

The invention relates to a mouse device, especially a mouse device and the method thereof applying the wireless transmission function by utilizing the technology of Micro-Electro-Mechanical System(MEMS). In addition, the invention can be employed to identify a user' signature image and to apparatus, such as general mouse, 3D wrist-watch type mouse, joystick, finger mouse, cursor pen, 3D game gun pad, low cost position detector, and coin size motion detector.

2. Related Art

With fast development of technology and science, the leading semi-conductor, information and electronic industries have been increasing growing resulting in apparently changes in a variety of applications. The changes not only accomplish better performance of science and technology, but also enhance the living qualities of human beings with alternation of people's life styles. It has much impact on the kind of electronic-consuming products by science and technology, such as personal computer(PC), mouse, scanner, mobile phone, personal digital assistance (PDA), etc. Therefore, people have more strict requirements and demands on these products.

Seeing that electronic products have come into the market with the design of “slim-and-light” resulting in much impact on the increasingly strict demands for a variety of peripheral components and parts and the accuracy and size of a processing equipment. Therefore, another revolution in manufacturing technology is gradually toward the directions of super-precision, high-density, high-speed, intelligent, micro-miniaturization, such and such, to generate “Next Generation Manufacturing Technology”, which is required by industries in the 21 st century. The chief development of the next Generation Manufacturing Technology can be divided into two sections: the Nano technology and the MEMS technology. The former technology is a manufacturing technology with processing accuracy ranging 102 nm˜10-1 nm; where the latter one utilizes the processing technologies of both Nano and micron for developing micro components and parts and integrating the systems of micro electric circuits and controller. Besides, the latter technology more focuses on the development of MEMS key components and parts and specific manufacturing technology of integrated micro-components, integrates micro-actuators, micro-sensors and micro-controllers, in addition, promotes intelligent integrated MEMS.

The product, which has been brought into practice, and the domain thereof are still not prevalence, however, the revolutionary reformation in the domain of the mouse design is a concerned subject to all. At present, mainly utilized mouse devices include rolling ball employed in the mechanic mouse and LED mouse, etc. These kinds of mouse devices have some drawbacks, for instance, a mechanic mouse with a rolling ball, which is sometimes run down, has to be executed on a mouse pad; whereas a LED mouse has a certain distance limitation, as well as a certain level coordination of the receiver thereof, due to the line movement of light. These drawbacks of mouse devices are still limited in the reformation of connector hardware, not the renovation of a whole new mouse device. In addition, currently used signature identification apparatuses on the market chiefly apply notepads or overall handwriting input devices, both of which are not applicable to mouse devices. Besides, the identification methods mostly employ contrasts by graphical nodes, not considers changing speed of each unique signature. In view of the foregoing problems, it can be solved through a mouse device design with the function of wireless transmission and the application of the latest MEMS technology, together with a specific identification system, which has the functions of identifying changeable signature acceleration or velocity of a user.

### SUMMARY OF THE INVENTION

In view of the foregoing problems, the invention aims at providing a mouse device and method with the wireless transmission function through a Thermal MEMS chip to sense moving routes and displacement of a mouse device. Moreover, the method of an applied force can be utilized for calculating acceleration and verify a user's signature habit through acquired velocity or acceleration, and then, transmit information to the data processing apparatus through the technology of RF wireless transmission. As to the technologies of both Thermal MEMS and RF wireless transmission enable a mouse device to execute normal effects sensing the displacement, even in-the-air, without through light refraction, light reflection or a smooth surface.

Besides, the invention further provides accurate on/off switches to control the Thermal MEMS chip through the form of a pen-shape mouse resulting from the substantially reduced volume of a mouse. Based on the experimental results, the optimal sensitivity can be acquired by specific angles; therefore, the invention employs the on/off switches to further enhance the accuracy of the signature identification. According to the description above, the invention not only changes a mouse design into that with the wireless transmission function, but also heightens the convenience and stability of a mouse device. Moreover, the technology improvement decreases the cost and substantially reduces the volume of a mouse device for the next new ear.

The invention consists of at least the following modules: a MEMS sensor, an Interface Box, and a RF-SoC(Radio Frequency-System-on-Chip) module.

The invention comprises at least the following steps: detecting the existence of a force through the MEMS; generating acceleration based on the force; analyzing and calculating acceleration through the Interface Box; and at last, transferring the result to the data processing apparatus through the RF-SoC module.

To enable a further understanding of the objective, structural features and the function of the present invention, the detailed descriptions of the preferred embodiments are followed by the brief descriptions of the drawings below.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1 is a simplified schematic representative of Micro-Electro-Mechanical System(MEMS) according to the invention;

FIG. 2 is a structural diagram of applied mouse device with the wireless transmission system to according to the invention;

FIG. 3 a structural diagram of applied pen-shape mouse with the wireless transmission system to according to the invention;

FIG. 4 is a schematic representative of MEMS according to the invention;

FIG. 5a is a schematic representative of the micro-pressure switch module under the status of click type based on the invention;

FIG. 5b is a schematic representative of the micro-pressure switch module under the status of stiff type based on the invention;

FIG. 6 is a flowcharted representative of the method of the mouse device with the wireless transmission function based on the invention;

FIGS. 7a and 7b are flowcharted representatives of the signature identification method of the mouse device with the wireless transmission function based on the invention; and

FIGS. 8a and 8b are preferred embodiments of the signature identification method of the mouse device with the wireless transmission function based on the invention.

### DETAILED DESCRIPTION OF THE INVENTION

The invention proposes a mouse device and method utilizing wireless transmission for renovating currently used mouse device through the technologies of both RF wireless transmission and MEMS. Information transmission of the invention, which differs from that from the past, enables a mouse device to function on any surface (including in-the-air) and detects an transform force into signal, which can be received by the data processing apparatus without applying any tracking ball, LED, light sensor, and mouse pad.

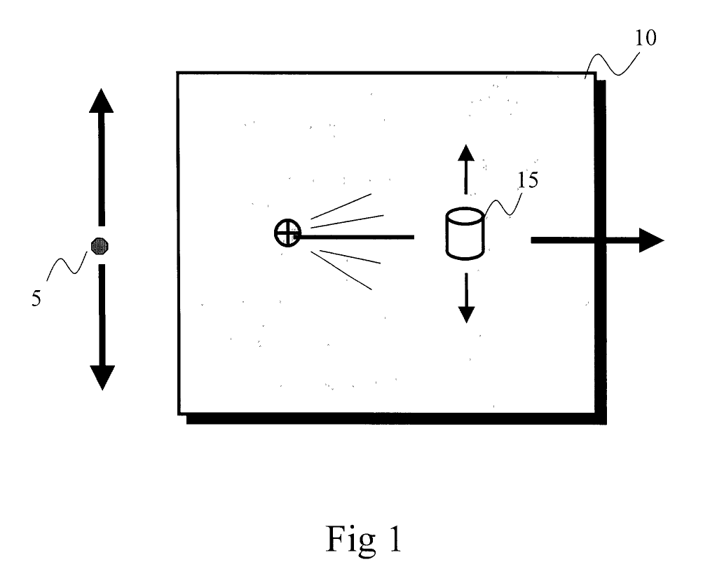

We will use a preferred embodiment to illustrate the feasibility of the invention by the said technology above. As shown in FIG. 1, the simplified schematic representative of Micro-Electro-Mechanical System(MEMS) according to the invention is further depicted as follows.

First, a force is applied by a force-applied point 5 to a MEMS sensor 10, which consists of a mass 15, m, and the MEMS sensor 10 can be a chip. According to the theory of mechanics, acceleration is generated when a force is applied to the mass 15; besides, a velocity, which is equal to integral of acceleration, where displacement is integral of velocity. With practical MEMS, two dimensions are needed, namely, X and Y directions. External force applied to MEMS causes mass X and mass Y to move accordingly. This generates ax and ay, i.e., acceleration in X and Y direction respectively. These two accelerations can be executed through other components and parts provided by the invention.

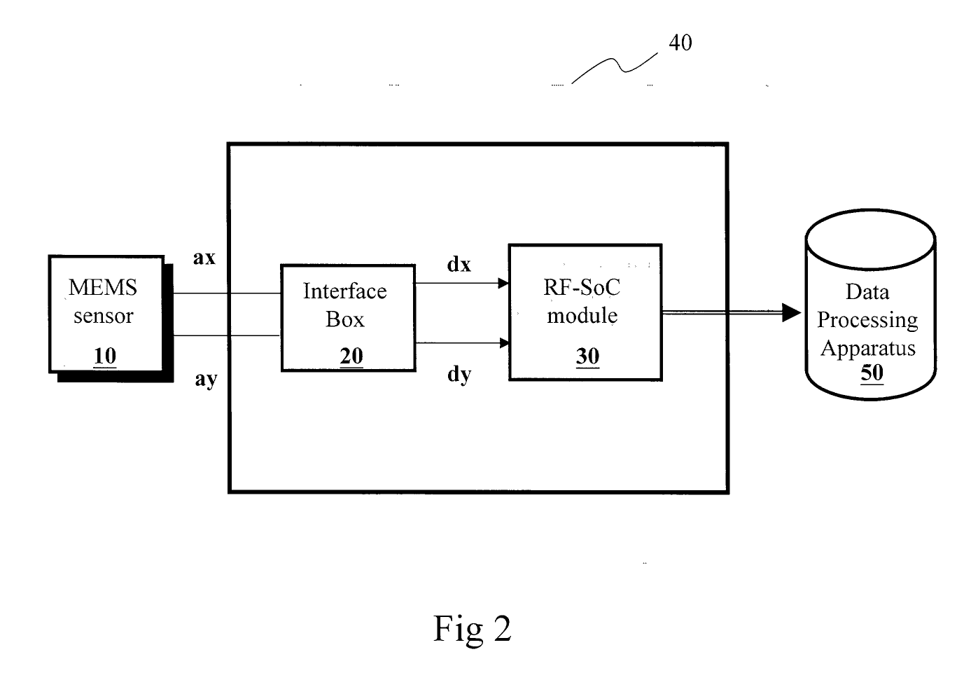

FIG. 2, the structural diagram of applied mouse device with the wireless transmission system to according to the invention, illustrates basic modules of the wireless transmission of a mouse device as follows.

The structural diagram of the invention comprises the following modules: A wireless mouse chip system 40 represents the mouse device connecting to a data processing apparatus 50 and transmits signal of the system into the data processing apparatus 50 for further data processing. The wireless mouse chip system 40 further comprises a MEMS sensor 10, an Interface Box 20, a RF-SoC module 30; these three modules mainly control the generations and communications of all signals of the system. The details are further depicted as follows.

1. MEMS sensor 10, the module, constituted by a thermal MEMS chip, is to sense the status of applied force and detect the direction of the applied force and velocity, analyze and quantify acceleration, which is generated by the force, by thermocouples. The module can be a 2-D MEMS to make a mouse device with lower cost, in addition, tilt angle of the MEMS sensor 10 with respective to sea water level enables the best sensitivity. Besides, the module transfers the status and acceleration of detected force to the Interface Box 20.

2. Interface Box 20, the module is a signal processing to remove un-necessary noise and interference, transfer the direction and acceleration of the applied force into an effective displacement. In addition, the module identifies and removes gravity effect and simulates a coefficient to rectify the status without moving velocity and to avoid the problem, which is unable to sense force by MEMS sensor 10.

3. RF-SoC module 30, the module is to transmit the relative variations of displacement by the force to the data processing apparatus 50 with analyzed displacement signals transmission. The RF-SoC module 30 transmits information through RF wireless transmission within the frequency ranges of 900 MHz or 2.4 Ghz or Industry, Science, Medical (ISM) for receiving signals from other RF wireless transmission receiver.

The said data processing apparatus 50 can be a desktop computer, a portable notebook(NB), a personal digital assistance (PDA), a mobile phone, a hand-hold data processing apparatus, etc., or other apparatus with any platform.

The wireless mouse chip system 40, comprising the MEMS sensor 10, the Interface Box 20 and the RF-SoC module 30, can be constituted by at least one chip and installed in any kind of mouse device.

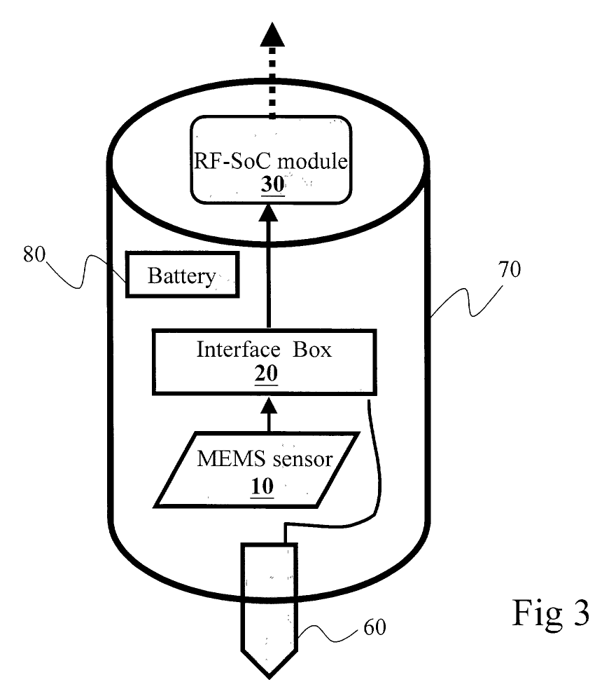

A preferred embodiment of the invention with reference to FIG. 3, the structural diagram of applied pen-shape mouse with the wireless transmission system, is described as follows.

As shown in FIG. 2 that the same modules, a MEMS sensor 10, an Interface Box 20, and a RF-SoC 30, are included in the pen-shape mouse body 70 adding a micro pressure switch module 60 and a Battery 80.

1. The micro pressure switch module 60, connecting to the Interface Box 20 is to control the start-up and switch on/off of the MEMS sensor and is able to verify the position of the mouse cursor and execute confirmed actions. Besides, the module can identify a user's signature by the operation of click type, which utilizes tiny switch difference to verify the switch on/off.

2. The Battery 80, is to provide with power supply for pen-shape mouse body 70 to operate.

The pen-shape mouse body 70 keeps the best sensitivity when the angle of the MEMS sensor 10 reaches the sea water level. The micro pressure switch module 60 and the MEMS 10 can verify the position of the mouse cursor and confirm the action of double Click; where the pen-shape mouse body 70 is to transfer a basic 2-D image into a 4-D signature identification and store the identification result through velocity curve generated by the force.

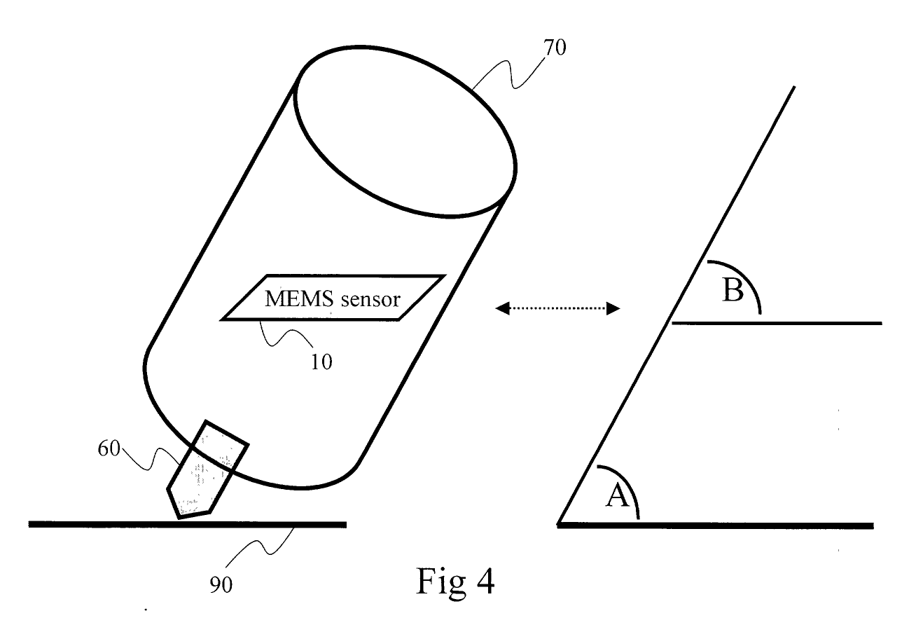

FIG. 4, the schematic representative of MEMS according to the invention, is illustrated as follows.

Angle A is a writing angle of a user, also an applied force angle between the micro pressure switch module 60 and the writing surface 90; where angle B is an angle between the MEMS sensor 10 and the micro pressure switch module. To get the best sensitivity, a user tilts the wireless identification system 70 to a certain angle to enable angle A to be equal to angle B and enable the MEMS mounting angle to keep the MEMS sensor 10 chip surface angle horizontal with respect to sea water level.

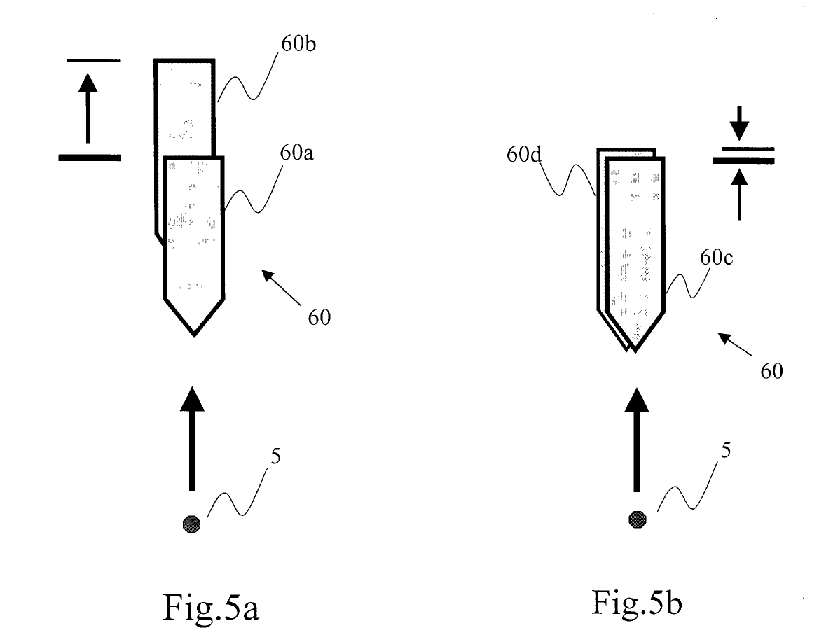

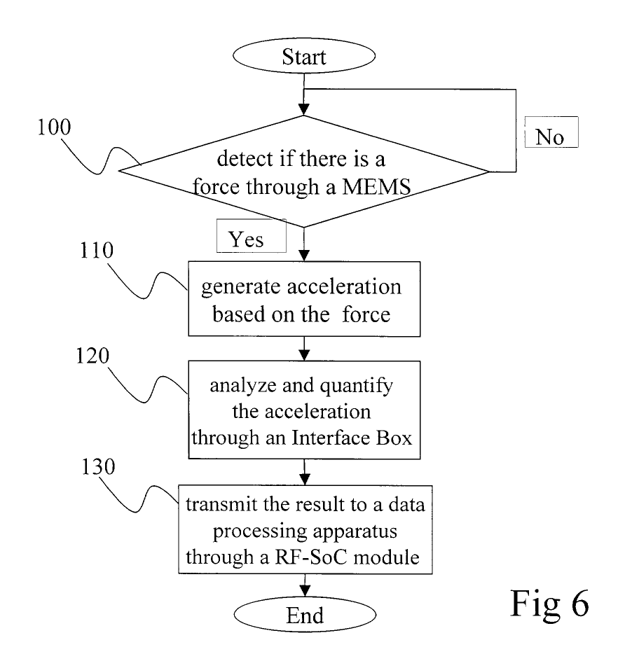

FIG. 5a, the schematic representative of the micro-pressure switch module under the status of click type based on the invention, is depicted as follows.

The drawing describes the Click Type status of the micro-pressure switch module 60. First, 60a is the applied pressure status when the starting position of the micro pressure switch module 60 is under the status of click type. When the micro pressure switch module 60 receives pressure applied by the force-applied point 5, 60b is the applied pressure status when the last position of the micro pressure switch module 60 is under the status of click type. The distance between 60a and 60b is rather different. A user is able to easily press the micro-pressure switch module 60 to execute a command through the click type, when s/he wants to confirm the position of the mouse cursor to give the command. According to the preceding description, the user must feel the difference due to a certain pressing distance. As to the application of signature identification, the invention provides another type as shown in FIG. 5b, the schematic representative of the micro-pressure switch module under the status of stiff type based on the invention. The starting position of the micro-pressure switch module 60 under the status of stiff type is 60c, which is not under applied pressure. When pressure is applied to the force-applied point 5, the last position of the micro-pressure switch module 60 under the status of stiff type is 60d. It is obvious that the distance between the original position, 60c, and the new position, 60d, is almost the same, i.e., the micro-pressure switch module 60 changes even if only small pressure is applied to the force-applied point 5. In other word, the micro pressure switch module 60 under the status of stiff type keeps the switch on status, therefore, the user can easily write without feeling any distance difference like under the click type.

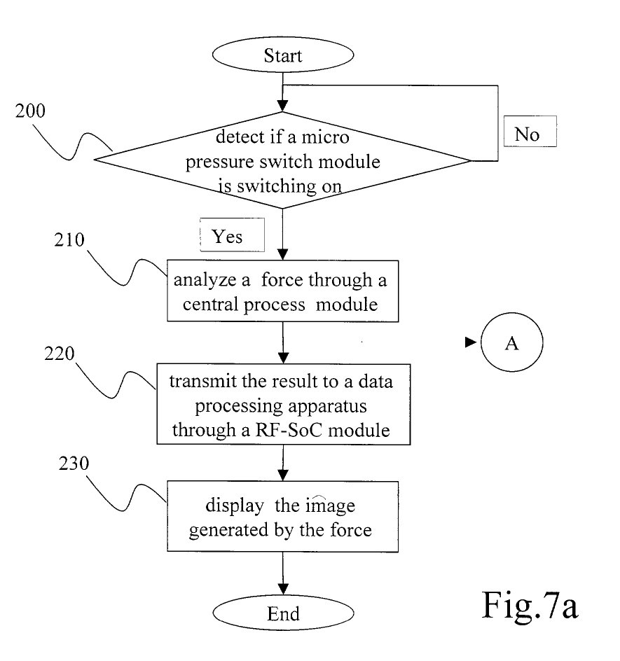

FIG. 6, the flowcharted representative of the method of the mouse device with the wireless transmission function, is further illustrated as follows.

First, the wireless mouse chip system 40 detects if there is an applied force through a MEMS sensor 10 (step 100). If NO, the step 100 keeps the status of standby. If YES, the force generates a acceleration(step 110), which is detected by the MEMS sensor 10 and analyzed and calculated by the Interface Box 20(step 120) to come out a displacement result, which is transferred from the RF-SoC module 30 to the data processing apparatus 50(step 130); the flow ends up then.

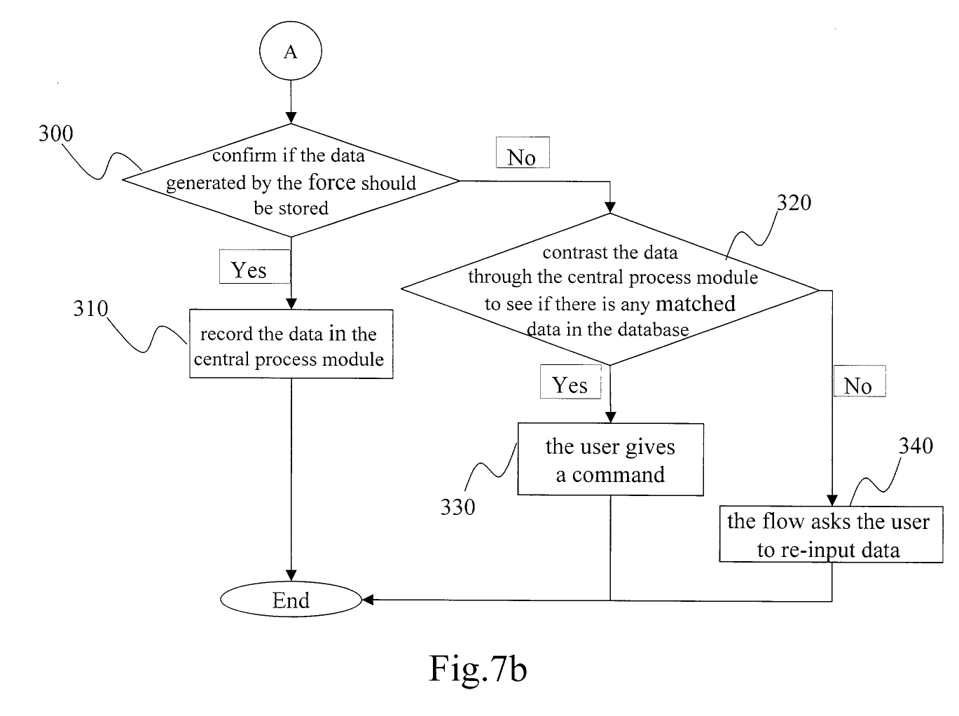

FIG. 7a, the flowcharted representatives of the signature identification method of the mouse device with the wireless transmission function based on the invention, is further illustrated as follows.

First, the wireless mouse chip system 40 of the said invention starts to detect if the micro pressure switch module 60 is at the switched on status(step 200). If NO, the step keeps standby until there is a force applied. If YES, there is a force received, the force is analyzed by the Interface Box 20(step 210). The detailed flow will be further described by process A as follows later. The RF-SoC module 30, then, transfers the analyzed result to the data processing apparatus 50(step 220) and the graph of the force is displayed through the data processing apparatus 50(step 230). The graph, a user's signature image, can be a character or a symbol to be identified. The flow ends up here.

The flow of process A is as shown in FIG. 7b:

Process A starts to analyze the force. First, the flow confirms if data generated by the force should be stored into the Interface Box 20 by the user(step 300), if YES, the data is stored into the Interface Box 20(step 310), i.e., the data is the reference in the signature data for the signature identification afterwards. The flow, then, ends up here. If NO, the flow starts to carry out the contrast process of the data to see if there is the same data in the database through the Interface Box 20(step 320). The Interface Box 20 retrieves data from the signature data to compare with the data, the contrast method is to transfer a basic 2-D Static space image into a 4-D signature identification(2-D static space image +2-D dynamic space image). The identification result is stored by acceleration or velocity curve of the force to generate a 2-D dynamic space image. Seeing that different users have their unique applied methods and tempos resulting from their signature habits, therefore the identification method of 2-D dynamic space image can readily distinguish the signature identification of the user from an imitator, who has the problem of learning the accuracy of the signature. If there is no data in the database matched with the identification result, the flow will ask the user to re-input data(step 340); or if there is the same data in the database, the user is able to give a command(step 330). The flow ends up here.

### ACHIEVEMENTS OF THE INVENTION

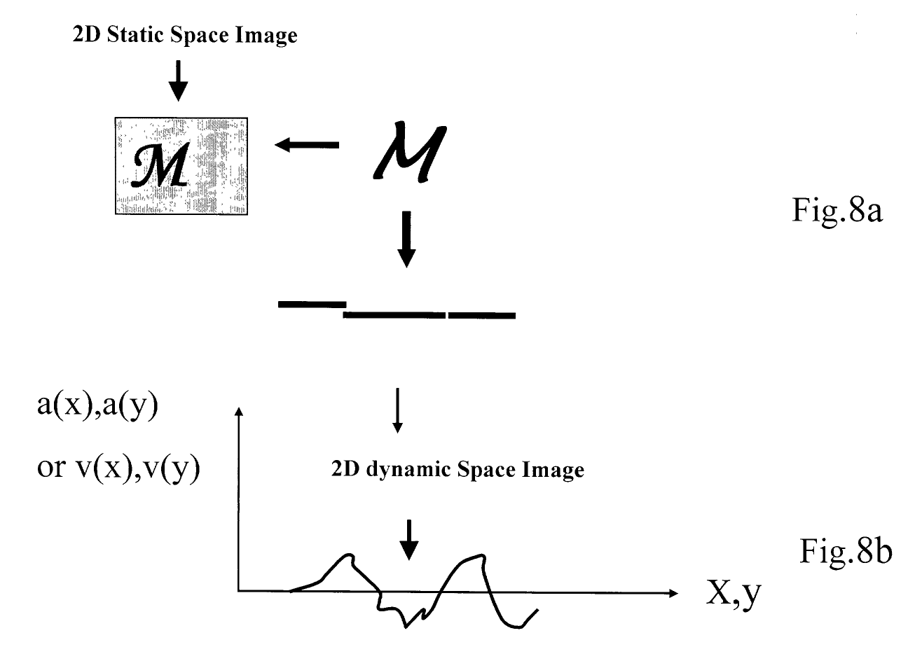

FIGS. 8a and 8b are preferred embodiments of the signature identification method of the mouse device with the wireless transmission function based on the invention

First, as each person has different writing signature type, but the traditional identification method using 2-D static space image can be easily imitated by others. Therefore, another method adding the method of 2-D dynamic space image that is described as follows can effectively prevent intended imitation. Taking letter “M” as an example, first, a(x), a(y) or v(x), v(y) curves can be obtained through the MEMS sensor 10 for decomposing the letter “M” into a piecewise linear line. For instance, a letter is stretched out into a line, like a rubber band. The method utilizing a(x), a(y) or v(x), v(y) curves for representing unique a(x), a(y) for each Xj and Yj points. The letter “M” will be stored into the signature data through Interface Box 20 with 2D dynamic image. Besides, data curve by traditional 2-D static space image is also stored into the signature data to generate a kind of method of 4D-signature identifier.

The mouse device and method thereof with the wireless transmission function of the invention is a revolutionary product applying the technology of wireless transmission to computer peripheral input apparatuses, such as a mouse, a joystick, and a cursor pen, etc. therefore, a user can give a command even is not with a data processing apparatus on hand, in addition, experiences the virtual reality through a unique 3D technology. Moreover, the invention enables the mouse device to carry out the signature identification by the MEMS sensor to detect applied force and calculate the acceleration and velocity. The identification uses unique signature of each person, which method is an advantage to be applied to various fields in the future. Therefore, all computer peripheral input apparatuses, which require the identification mechanism for user confirmation, can employ the disclosed apparatus to carry out signature identification replacing the methods of password mechanism, ID card imitation, etc.

In addition, the invention provides an open PC environment by replacing currently used standardized computer input device—mouse with a more suitable, widely applied and easily operated input apparatus. The invention mainly employs MEMS sensor by the technology of MEMS manufacturing; therefore, the sensor will generate the changes of signals through precise controller and simulate cursor movements from the screen by mouse, and other functions. The invention, with the advantages of tiny size, low electricity consumption, and simplified operation, can be applied to a variety of fields through various data processing apparatuses (such as computer, PDA, etc.). The powerful functions of the invention can be applied for more convenient using environment.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A mouse device applying the wireless transmission system comprises a wireless mouse chip system, which applies a sensor by the technology of Micro Electro Mechanical System(MEMS) manufacturing to transmit a controlled signal of a user to a data processing apparatus for operations; the wireless mouse chip system further comprising:
a MEMS, to sense the status of a applied force, detect the direction and acceleration of the applied force and generate a changing message;
an Interface Box, to remove un-necessary noise and interference, transfer the direction and acceleration of the applied force into an effective displacement, and transfer the changing message into a motion;
a RF-SoC module, to transfer the variation of relative displacement caused by the force to the data processing apparatus and transmit the analyzed moving message; and
wherein the MEMS, the Interface Box and the RF-SoC module provided by the wireless mouse chip system are constituted by at least one chip.

2. The mouse device applying the wireless transmission system in accordance with claim 1, wherein the MEMS is constituted by a Thermal MEMS chip to be analyzed and quantified by thermocouples generated by the temperature differential in the velocity of the applied force.

3. The mouse device applying the wireless transmission system in accordance with claim 1, wherein the MEMS can be a 2-D MEMS for manufacturing a mouse device with lower cost.

4. The mouse device applying the wireless transmission system in accordance with claim 1, wherein the MEMS tilt angle reaches the sea water level enables the best sensitivity.

5. The mouse device applying the wireless transmission system in accordance with claim 1, wherein the Interface Box can identify and remove gravity effect and simulate a coefficient for rectifying the status without moving velocity.

6. The mouse device applying the wireless transmission system in accordance with claim 1, wherein the RF-SoC transfers messages through the RF wireless transmission within the frequency ranges of 900 MHz or 2.4 Ghz or Industry, Science, Medical(ISM) for receiving signals by other wireless transmission receiver.

7. The mouse device applying the wireless transmission system in accordance with claim 1, wherein the data processing apparatus can be one of the combination of a notebook(NB), a personal digital assistance (PDA), a mobile phone, a hand-hold data processing apparatus.

8. The mouse device applying the wireless transmission system in accordance with claim 1, wherein the wireless mouse chip system can be installed in any kind of mouse device.

9. A pen-shape mouse applying the wireless transmission system is applied to a sensor by the technology of MEMS manufacturing to transmit controlled signals of a user to a data processing apparatus for operations; the pen-shape mouse further comprising,
a MEMS, to sense the status of a force, measure the direction and acceleration of the applied force and generate a changing message;
an Interface Box, to remove un-necessary noise and interference, transfer direction and acceleration of the applied force into an effective displacement;
moreover, operate the signal of a signature identification, record at least one signature data and transfer the changing message into a moving message;
a RF-SoC, to transmit the variation of relative displacement caused by the applied force to the data processing apparatus and transfer the moving message correctly;
a micro pressure switch module, to connect the Interface Box for controlling the start-up status of the force of the MEMS; and
a Battery, to provide with power supply for the pen-shape mouse operations.

10. The pen-shape mouse applying the wireless transmission system in accordance with claim 9, wherein the MEMS is constituted by a Thermal MEMS chip and analyze and quantify acceleration through thermocouples generated by the force.

11. The pen-shape mouse applying the wireless transmission system in accordance with claim 9, wherein the MEMS enables the pen-shape mouse to obtain the best sensitivity, when the angle of the MEMS reaches the sea water level.

12. The pen-shape mouse applying the wireless transmission system in accordance with claim 9, wherein the Interface Box can identify and remove the gravity effect and simulate a coefficient for rectifying the status without the moving velocity.

13. The pen-shape mouse applying the wireless transmission system in accordance with claim 9, wherein the RF-SoC module transmits message through the RF wireless transmission within the frequency ranges of 900 MHz or 2.4 Ghz or ISM for other RF wireless transmission receivers to receive information.

14. The pen-shape mouse applying the wireless transmission system in accordance with claim 9, wherein the micro-pressure switch module and the MEMS can be used for verify the position of the mouse cursor and confirm the action of double clicking.

15. The pen-shape mouse applying the wireless transmission system in accordance with claim 9, wherein the micro-pressure switch module is able to verify the position of the mouse cursor and execute a confirmed command.

16. The pen-shape mouse applying the wireless transmission system in accordance with claim 9, wherein the micro pressure switch module is able to carry out signature identification through the click type operation.

17. The pen-shape mouse applying the wireless transmission system in accordance with claim 16, wherein the click type operation utilizes a tiny switch difference for verifying the switch on status.

18. The pen-shape mouse applying the wireless transmission system in accordance with claim 16, wherein the pen-shape mouse combines a basic 2-D static image with a velocity or acceleration curve image of a 2-D dynamic space generated by the force to be transferred into a 4-D signature identification, and enables the identification result to be stored.

19. The pen-shape mouse applying the wireless transmission system in accordance with claim 9, wherein the data processing apparatus can be one of the combination of a notebook(NB), a personal digital assistance (PDA), a mobile phone, a hand-hold data processing apparatus.

20. The pen-shape mouse applying the wireless transmission system in accordance with claim 9, wherein the MEMS, the Interface Box and the RF-SoC module are constituted by at least one chip each.

21. An signature identification method applying the wireless transmission mouse utilizes the sensor made by a MEMS technology for carrying out a user's signature identification; the method further comprising the following steps:
detecting if the micro-pressure switch module is on the switch on status;
analyzing a force through the Interface Box;
transmitting the result from a RF-SoC module to a data processing apparatus; and
displaying the 2-D dynamic space image generated by the force.

22. The signature identification method applying the wireless transmission system in accordance with claim 21, wherein the step of transmitting the result from a RF-SoC module to a data processing apparatus carries out the data transmission within the frequency ranges of 900 MHz or 2.4 GHz or ISM for other RF wireless transmission receiver to receive signals.

23. The signature identification method applying the wireless transmission system in accordance with claim 21, wherein the method that the pen-shape mouse combines a basic 2-D static image with a velocity or acceleration curve image of a 2-D dynamic space generated by the force to be transferred into a 4-D signature identification further enables the identification result to be stored through velocity curve generated by the force.
